(19) United States
(12) Patent Application Publication
(10) Pub. No.: US 2005/0099267 A1
(43) Pub. Date: May 12, 2005

(54) Communication station for communication with transponders and further communication stations with the aid of different transmission parameters

(76) Inventors: Franz Amtmann, Graz (AT); Holger Kunkat, Graz (AT); Reinhard Meindl, Graz (AT); Stefan Posch, Graz (AT); Klemens Breitfuss, Voitsberg (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/507,534

(22) PCT Filed: Feb. 21, 2002
(86) PCT No.: PCT/IB03/00678

(30) Foreign Application Priority Data
Mar. 13, 2002 (EP) 02100245.6

(51) Int. Cl. G06K 7/00; H04Q 5/22

(52) U.S. Cl. 340/10.3; 340/10.1

(57) ABSTRACT

A communication station (1) is suitable for contactless communication with transponders and with other communication stations and comprises a first signal-processing circuit (28) and a second signal-processing circuit (29), the first signal-processing circuit (28) being designed for processing signals using at least one transmission parameter in a communication between the communication station (1) and at least one transponder, and the second signal-processing circuit (29) being designed for processing other signals using at least one other transmission parameter in a communication between the communication station (1) and at least one other communication station, and the transmission parameters used in the two signal-processing circuits (28, 29) differing from each other.

The invention relates to a communication station which is suitable for contactless communication with transponders and with other communication stations.

The invention further relates to an integrated circuit for a communication station which is suitable for contactless communication with transponders and with other communication stations.

Such a communication station is known from the patent document U.S. Pat. No. 5,929,778 A. It is explained in this patent document that a communication station can communicate with transponders and with other communication stations by electromagnetic means, and that the communication sequences executed for this can lead to a modulation and demodulation of signals, though more precise details were not given concerning the manner of the modulation and demodulation, nor concerning transmission parameters that are used for communication by the communication station with transponders and with other communication stations.

It is an object of the invention to improve a communication station which is suitable for contactless communication with transponders and with other communication stations in comparison with the communication station known from the patent document U.S. Pat. No. 5,929,778 A, and to implement a communication station and an integrated circuit for a communication station with which communication sequences between the communication station and transponders on the one hand and between the communication station and other communication stations on the other hand can be implemented in an unambiguously and precisely differentiable manner.

To achieve the object described above, inventive features are provided for a communication station according to the invention, so that a communication station as in the invention can be characterized in the following way, namely:

Communication station which is suitable for contactless communication with transponders and with other communication stations and which comprises first signal-processing means that are designed for processing signals and enable signals to be processed using at least one transmission parameter in a communication between the communication station and at least one transponder, and which comprises second signal-processing means that are designed for processing other signals and enable the other signals to be processed using at least one other transmission parameter in a communication between the communication station and at least one other communication station, wherein the at least one transmission parameter for processing the signals with the first signal-processing means and the at least one transmission parameter for processing the other signals with the second signal-processing means being transmission parameters differing from each other.

To achieve the object described above, inventive features are provided for an integrated circuit according to the invention, so that an integrated circuit as in the invention can be characterized in the following way, namely:

Integrated circuit for a communication station which is suitable for contactless communication with transponders and with other communication stations, wherein the integrated circuit comprises first signal-processing means that are designed for processing signals and enable signals to be processed using at least one transmission parameter in a communication between the communication station and at least one transponder, and the integrated circuit comprises second signal-processing means that are designed for processing other signals and enable the other signals to be processed using at least one other transmission parameter in a communication between the communication station and at least one other communication station, and wherein the at least one transmission parameter for processing the signals with the first signal-processing means and the at least one transmission parameter for processing the other signals with the second signal-processing means are transmission parameters differing from each other.

The provision of the features according to the invention achieves relatively easily, and by relatively easy means, that a communication sequence between the communication station according to the invention and transponders designed to co-operate with this communication station on the one hand and a communication sequence between the communication station according to the invention and further communication stations designed to co-operate with this communication station on the other hand can be distinguished from each other in a simple and definite way, so that even with simultaneous communication between the communication station according to the invention and transponders and further communication stations no reciprocal interference can occur during the communication processes or communication sequences simultaneously in progress, so that a high reliability in communication is ensured. Since a communication station according to the invention renders possible such simultaneous communication between the communication station and transponders on the one hand and between the communication station and further communication stations on the other hand in an interference-free manner, the advantage is gained that the total necessary communication time for the communicating of such a communication station with transponders and with other communication stations is much shorter, i.e. in comparison with a communication station with which it is not possible to communicate simultaneously in this way, but only successively in time between a communication station and transponders on the one hand and this communication station and further communication stations on the other hand.

For a communication station according to the invention or an integrated circuit according to the invention, it has proved very advantageous if the features as claimed in claim 2 and the features as claimed in claim 10 are additionally provided. As a result of these, the transmission signals occurring in the communication between the communication station according to the invention and transponders on the one hand, and in the communication between the communication station according to the invention and further communication stations on the other hand, which are transmitted by electromagnetic means, differ from each other with regard to their coding type, and can therefore be transmitted in a simple and reliable way unaffected by each other.

In the context explained above, it has proved especially advantageous if for a communication station according to the invention and an integrated circuit according to the invention the features as claimed in claim 3 and claim 4 and the features as claimed in claim 11 and 12, respectively, are additionally provided. These measures have proved especially advantageous in practice, because especially good differentiation between the transmission signals being transmitted is thereby achieved. The use of the Miller code has the advantage that the transmission signals transmitted to the transponders are relatively easy to decode. The use of the Manchester code has the advantage that the transmission signals transmitted from the transponders to the communication station 1 can be generated in the transponders with low energy expenditure, which is an advantage especially for so-called passive transponders. The use of the NRZ code has the advantage that high data transfer rates can be achieved, because this method manages on relatively modest frequency bandwidth.

For a communication station according to the invention or an integrated circuit according to the invention, it has further proved very advantageous if the features as claimed in claim 5 and the features as claimed in claim 13 are additionally provided. As a result of implementing these measures, the transmission signals occurring in communication between the communication station according to the invention and transponders on the one hand, and in communication between the communication station according to the invention and further communication stations on the other hand, and being transmitted by electromagnetic means, differ from each other in their modulation type, which is also very advantageous with regard to the best possible differentiability and with regard to the smallest possible mutual interference.

In the context explained above, it has proved especially advantageous if for a communication station according to the invention and an integrated circuit according to the invention the features as claimed in claim 6 and claim 7 and claim 8 and the features as claimed in claim 14 and claim 15 and claim 16, respectively, are additionally provided. These measures have proved especially advantageous because the amplitude modulation of the transfer signals to be transferred from the communication station according to the invention to transponders is advantageous with regard to a demodulation of the transfer signals in the transponders in the most simple manner possible and consequently with the lowest possible energy expenditure, and because the phase modulation and in particular the phase modulation according to the BPSK method of the transfer signals to be transferred from the communication station according to the invention to further communication stations is advantageous with regard to the highest possible signal/noise ratio and with regard to generating these transfer signals in the communication station with the lowest possible energy expenditure.

The above and further aspects of the invention will emerge from the embodiment described in the following, and are explained using this embodiment.

The invention will be further described with reference to examples of embodiments shown in the drawing to which, however, the invention is not restricted.

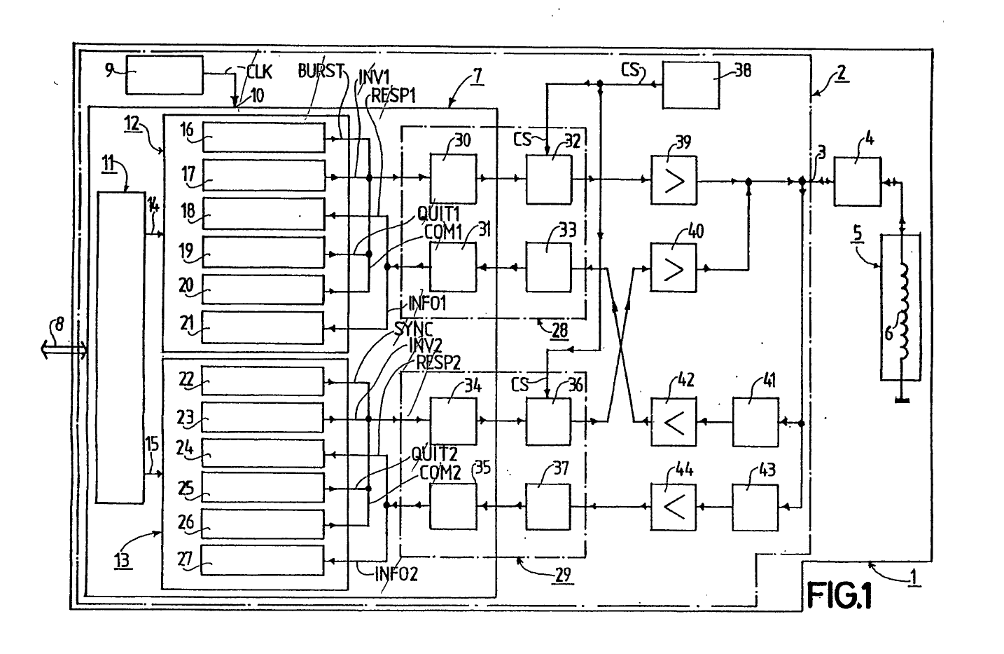

FIG. 1 shows schematically in the form of a block diagram an essential part in this context of a communication station according to the invention.

FIG. 1 shows a communication station 1. The communication station 1 is suitable for contactless communication with transponders (not shown) and with other communication stations (also not shown), the transponders and the other communication stations having a design suitable for communicating with the communication station 1.

The communication station 1 comprises an integrated circuit 2, by use of which a number of electrical modules and components is implemented, of which however only the modules and components essential in the present context are shown in FIG. 1. Connected to a pin 3 of the integrated circuit 2 are matching means 4, with the help of which output stages and input stages of the integrated circuit 2 are adapted to transmission means 5 of the communication station 1. The transmission means 5 comprise a transmission coil 6, with the help of which a communication can be executed by electromagnetic means between the communication station 1 and transponders suitable for this and further communication stations suitable for this. In such a communication, transmission signals are transmitted, i.e. sent, by the communication station 1 to the transponders or to the other communication stations, and also transmission signals are transmitted from the transponders or the other communication stations to the communication station 1, i.e. are received by the communication station 1.

The integrated circuit 2 comprises a microcomputer 7. A number of means and functions are or can be implemented with the help of the microcomputer 7, but only those means and functions essential in the present context are dealt with in more detail here. Instead of the microcomputer 7, the communication station 1 may alternatively comprise a hard-wired logic circuit. The microcomputer 7 is connected over a BUS connection 8 to a HOST computer that is not shown in FIG. 1. The microcomputer 7 may alternatively be connected over the BUS connection 8 to one or more other microcomputers. The integrated circuit 2 comprises a timing signal generator 9, by means of which a timing signal CLK can be generated, this timing signal CLK being fed to an input 10 of the microcomputer 7 for known purposes. The timing signal generator 9 may comprise a crystal provided outside the integrated circuit 2.

Communication-mode selection means 11 are implemented by means of the microcomputer 7. The communication-mode selection means 11 can choose between two communication types in this case, namely a first communication type and a second communication type, a communication between the communication station 1 and transponders being executed with the first communication type, and a communication between the communication station 1 and other communication stations being executed with the second communication type. The communication mode selection means 11 are developed to be controllable in a manner not shown in more detail such that the communication mode selection means 11 can be deliberately controlled. The communication mode selection means 11 may be controlled from the HOST computer via the BUS connection 8, for example. The communication mode selection means 11 may alternatively be controlled by means of an input keyboard. The control of the communication mode selection means 11 may also be effected by a so-called speech control facility, i.e. with spoken control commands.

It should be stressed at the outset that a communication in the first communication type occurs according to a station-transponder protocol and using at least one transmission parameter, and that a communication in the second communication type occurs according to a station-station protocol and using at least one other transmission parameter. To implement this, the integrated circuit 2 comprises the means explained in the following:

First protocol execution means 12 and second protocol execution means 13 are implemented by means of the microcomputer 7. The two protocol execution means 12 and 13 can be activated with the help of the communication mode selection means 11 via control connections 14 and 15.

The first protocol execution means 12 comprise energy supply signal generation means 16 and first inventorizing signal generation means 17 and first response signal recognition means 18 and first acknowledgement signal generation means 19 and first command signal generation means 20 and first information signal recognition means 21. With the help of the energy supply signal generation means 16, an energy supply signal BURST can be generated. By means of the first inventorizing signal generation means 17, a first inventorizing signal INV1 can be generated. By means of the first response signal recognition means 18, a first response signal RESP1 can be detected. By means of the first acknowledgement signal generation means 19, a first acknowledgement signal QUIT1 can be generated. By means of the first command signal generation means 20, first command signals COM1 can be generated; these may be a write command signal and a read command signal and many other command signals. By means of the first information signal recognition means 21, first information signals INFO1 can be detected; these may be signals read from a memory and many other information signals.

By means of the second protocol execution means 13, synchronization signal generation means 22 and second inventorizing signal generation means 23 and second response signal recognition means 24 and second acknowledgement signal generation means 25 and second command signal generation means 26 and second information signal recognition means 27 are implemented. By means of the synchronization signal generation means 22, a synchronization signal SYNC can be generated. By means of the second inventorizing signal generation means 23, a second inventorizing signal INV2 can be generated. By means of the second response signal recognition means 24, a second response signal RESP2 can be detected. By means of the second acknowledgement signal generation means 25, a second acknowledgement signal QUIT2 can be generated. By means of the second command signal generation means 26, second command signals COM2 may be generated; these may be write command signals and read command signals and many other command signals. By means of the second information signal recognition means 27, second information signals INFO2 can be detected; these may be signals read from a memory and other station information signals.

The first protocol execution means 12 are developed for processing the station-transponder protocol. By means of the first protocol execution means 12, a communication can be executed between the communication station 1 and at least one transponder, observing the station-transponder protocol. A special feature of the first protocol execution means 12 is that the first protocol execution means 12 comprise the energy supply signal generation means 16, which are designed for generating the energy supply signal BURST at each start of processing of the station-transponder protocol. A further special feature of the first protocol execution means 12 is that the first protocol execution means 12 are developed for processing a station-transponder protocol, which protocol is designed with regard to communication with the highest possible number of transponders during a protocol sequence.

The second protocol execution means 13 are developed for processing the station-station protocol. By means of the second protocol execution means 13, a communication can be executed between the communication station 1 and at least one further communication station, observing the station-station protocol. For this the second protocol execution means 13 are advantageously implemented such that the second protocol execution means 13 comprise the synchronization signal generation means 22, which are developed to generate the synchronization signal SYNC at each start of processing of the station-station protocol. In the communication station 1, the second protocol execution means 13 are advantageously developed for processing a station-station protocol, which is designed with regard to causing only the lowest possible energy consumption in the communication station 1 for a communication with at least one further communication station. Furthermore, in this present case the development is such that the second protocol execution means 13 are developed for processing a station-station protocol, which is designed with regard to the fastest possible setup of a communication link to at least one further communication station.

In the communication station 1 the essential fact is advantageously realized that the station-transponder protocol to be processed by means of the first protocol execution means 12 and the station-station protocol to processed by means of the second protocol execution means 13 differ from each other in respect of at least one protocol parameter. In this present case the two protocols differ in any case in that according to the station-transponder protocol the energy supply signal BURST is generated at the respective start of processing of this protocol, and that according to the station-station protocol the synchronization signal SYNC is generated at the respective start of processing of this protocol. Because of this difference, the two protocols are uniquely and unmistakably distinguishable from each other, so that the communication processes executed by the processing of these different protocols are also uniquely and definitely distinguishable from each other. The two different protocols are furthermore here chosen such that no mutual influence can occur with communication processes possibly running simultaneously between the communication station 1 and transponders on one hand, and between the communication station 1 and further communication stations on the other hand.

The station-transponder protocol may be a known protocol, such as protocols defined in international standards, for example in the international standards according to ISO 14443 or ISO15693, or in the currently emerging standard according to ISO18000.

The integrated circuit 2 comprises first signal-processing means 28 for processing signals generated or to be evaluated by means of the first protocol execution means 12. The integrated circuit 2 comprises second signal-processing means 29 for processing signals generated or to be evaluated by means of the second protocol execution means 13. With the help of the first signal-processing means 28, in a communication between the communication station 1 and at least one transponder, the signals generated or to be evaluated by means of the first protocol execution means 12 can be processed using two transmission parameters in this case. By means of the second signal-processing means 29, in a communication between the communication station 1 and at least one further communication station, the signals generated or to be evaluated by means of the second protocol execution means 13 can be processed using two other transmission parameters in this case. In the present context it is fundamental and advantageous that the two transmission parameters for processing the signals with the first signal-processing means 28 and the two transmission parameters for processing the other signals with the second signal-processing means 29 are transmission parameters differing from each other, which is dealt with later in more detail.

The first signal-processing means 28 comprise first encoding means 30 and first decoding means 31. The first encoding means 30 are developed for processing signals according to a first coding type, this first coding type representing a first transmission parameter. In the present case the first encoding means 30 are developed to process the signals according to a so-called Miller code. The first decoding means 31 are developed for processing signals according to a second coding type, this second coding type representing a second transmission parameter. In the present case the first decoding means 31 are developed to process the signals according to a so-called Manchester code, with use of a subcarrier. However, the first encoding means 30 and the first decoding means 31 may alternatively be developed for processing the signals fed to each of them according to the so-called Manchester code or another code, for example a so-called Return to Zero code (RZ code).

The first signal-processing means 28 further comprise first modulation means 32 and first demodulation means 33. The first modulation means 32 and first demodulation means 33 are developed for processing the signals fed to them according to a first modulation type. In the present case, the first modulation means 32 are formed by amplitude modulation means, and the first demodulation means 33 by amplitude demodulation means, so that the first modulation means 32 and the first demodulation means 33 are developed for processing signals according to an amplitude modulation as the first modulation type. This is a so-called ASK, which may be a 10% ASK, 12% ASK, 30% ASK, or 100% ASK, but other ASK modulations are possible as well. However, the first modulation means 32 and the first demodulation means 33 need not necessarily be developed for processing signals according to an amplitude modulation, but may alternatively be developed for processing signals according to a phase modulation, for example.

The second signal-processing means 29 comprise second encoding means 34 and second decoding means 35. The second encoding means 34 and the second decoding means 35 are developed for processing the signals fed to them according to a third encoding type as the transmission parameter. In the present case, the second encoding means 34 and the second decoding means 35 are developed for processing the signals fed to them according to a so-called NRZ code (Non Return to Zero code), so that this NRZ code forms a further transmission parameter, which is used in the communication station 1. However, the second encoding means 34 and the second decoding means 35 may alternatively be developed for processing signals fed to them according to a different code; for example, the so-called FM Zero code (FM0 code) may be used.

The second signal-processing means 29 further comprise second modulation means 36 and second demodulation means 37. The second modulation means 36 and second demodulation means 37 are developed for processing the signals fed to them according to a second modulation type. In the present case, the second modulation means 36 are formed by phase modulation means, and the second demodulation means 37 by phase demodulation means. Here the phase modulation means provided as second modulation means 36 and the phase demodulation means provided as second demodulation means 37 are developed to process the signals fed to them according to the so-called BPSK (Binary Phase Shift Keying) method. However, the second modulation means 36 and the second demodulation means 37 may alternatively be developed for processing the signals fed to them according to a different modulation type, for example for frequency modulation or simple phase modulation, or amplitude modulation.

The integrated circuit 2 comprises a carrier signal generator 38 capable of generating a carrier signal CS which is fed to the first modulation means 32 and the second modulation means 36 for modulation purposes.

The construction of the first modulation means 32 as amplitude modulation means has the important advantage that the amplitude-modulated transmission signals which can be generated with the help of the first modulation means 32, and which are transmitted to transponders, can easily be demodulated in the respective transponder with only a very modest energy requirement.

In the present case, the construction of the second modulation means 36 as phase modulation means offers the important advantage that the generation of the transmission signals which can be generated with the help of the second modulation means 36, and which are transmitted to other communication stations, ensures a high signal/noise ratio and also manages with relatively little transmission energy, so that in this case in the communication station 1 only a modest energy expenditure is required for the second modulation means 36, which is a great advantage especially if the communication station 1 is an element in a portable device powered by at least one battery or a rechargeable battery, since this results in a long useful life for this means of energy supply.

From the choice of different encoding types and different modulation types, i.e. transmission parameters, for a communication according to the station-transponder protocol between the communication station 1 and transponders on one hand, and for a communication according to the station-station protocol between the communication station 1 and further communication stations on the other hand, it is advantageously ensured that these communication processes can be executed simultaneously or at least partially simultaneously, if so desired, and still not be influenced or interrupted by one another.

Signals processed in the first signal-processing means 28 with the help of the first encoding means 30 and the first modulation means 32 are fed to first amplifying means 39, and output from the first amplifying means 39 via the pin 3 to the matching means 4 and subsequently to the transfer means 5.

Signals processed in the second signal-processing means 29 with the help of the second encoding means 34 and the second modulation means 36 are fed to second amplifying means 40, and output from the second amplifying means 40 via the pin 3 to the matching means 4 and subsequently to the transfer means 5.

Signals received with the transmission means 5 and fed to the matching means 4 are fed through the pin 3 of the integrated circuit 2. If these are signals that were transmission in a communication between the communication station 1 and transponders to the communication station 1, then these signals are filtered out with the help of first filter means 41 and fed via third amplifying means 42 to the first demodulation means 33 of the first signal-processing means 28. Here the amplification factor of the third amplifying means 42 may also be smaller than one (1). On the other hand, if these are signals that were transmitted in a communication between the communication station 1 and further communication stations to the communication station 1, then these signals are filtered out with the help of second filter means 43 and fed via fourth amplifying means 44 to the second demodulation means 37 of the second signal-processing means 29.

A brief description now follows of a possible communication sequence in the processing of the station-transponder protocol, and of a further possible communication sequence in the processing of the station-station protocol, these being only possible examples, however.

In the processing of the station-transponder protocol, the energy supply signal BURST is generated at each start of processing of this protocol, with the help of the energy supply signal generation means 16, and for a minimum duration of 1.0 msec. The energy supply signal BURST is transmitted to all transponders in communication connection with the communication station 1, and it is thus ensured that all transponders are supplied with sufficient energy. It is assumed here that these are so-called passive transponders, which do not have any energy supply of their own, with the help of a battery, for example. After this, the first inventorizing signal INV1 is generated by of the first inventorizing signal generation means 17, an inventorizing procedure thereby being started for all transponders in communication connection with the communication station 1. From each transponder in communication connection with the communication station 1, a first response signal RESP1 is output and transmitted to the communication station 1, which detects, with the help of the first response signal recognition means 18, either the conflict between at least two such first response signals RESP1 from at least two transponders, or a clear recognition of one first response signal RESP1 in each case from a single transponder only. To each uniquely detected transponder, a first acknowledgement signal QUIT1 is transmitted, generated by the first acknowledgement signal generation means 19. After such an acknowledgement with the help of the first acknowledgement signal QUIT1, a communication follows between the communication station 1 and the respective identified and acknowledged transponder signal, this communication being executed as a result of the respective first command signal COM1; it may be a reading of data from a relevant transponder or a writing of data to a relevant transponder, or other data exchange transactions. The respective first command signal COM1 is generated here by the first command signal generation means 20. Data or information transferred from a transponder to the communication station 1 during a data exchange transaction carried out as a result of such a first command signal COM1 is then recognized by the first information signal recognition means 21, whereupon further processing of the detected information takes place in the microcomputer 7 or in the HOST computer connected to the microcomputer 7 over the BUS connection 8.

In a communication process according to the station-station protocol, the synchronization signal SYNC is generated at the respective start of this protocol by the synchronization signal generation means 22, and then transmitted from the communication station 1 to all other communication stations 1 in communication connection with the communication station 1. It is thereby ensured that by evaluation of the synchronization signal SYNC in the other communication stations, a synchronization of the data processing transactions in all communication stations participating in a communication can be carried out in a simple and rapid way. This is necessary because each such communication station 1 has its own quartz oscillator 9, and these quartz oscillators 9 do not work at exactly the same frequencies, which without any synchronization would lead to unchecked data processing, which would inevitably lead to data recognition errors in a communication between the communication stations. After the generation and output of the synchronization signal SYNC, a sequence analogous to the processing described above for the station-transponder protocol occurs in the case assumed here, the signals JNV2, RESP2, QUIT2, CON2, and IFO2 then being processed in an analogous manner.

For a communication between the communication station 1 and transponders according to the station-transponder protocol, there is no need to set up a synchronization as described above, because in the transponders involved in such a communication a timing signal is derived from the transmission signal transmitted from the communication station 1 to the transponders, and synchronous operation is thus achieved with the help of this derived timing signal.

Concerning the previously described communication station 1, it should also be mentioned that the communication station 1 may also present two matching means independent of each other, and two transfer means independent of each other, one matching means and one linked transfer means being used in each case for one of the two possible communication types. A transmission characteristic optimally adapted to the particular communication type can thereby be achieved for the communication station 1. For the two communication types, the respective communication may be by inductive means, the transfer means then being developed as transformer coupled transmission coils. If the communication is to take place at very high frequencies for the two communication types, the transfer means are preferably developed as so-called dipoles.

Concerning the previously described communication station 1, it should also be mentioned that the communication station 1 may be developed as a separate facility or as a separate device. In a preferred application, the communication station 1 is an element in a portable device, for example a mobile phone or a Personal Digital Assistant (PDA).

1. A communication station which is suitable for contactless communication with transponders and with other communication stations and which comprises first signal-processing means that are designed for processing signals and enable signals to be processed using at least one transmission parameter in a communication between the communication station and at least one transponder, and which comprises second signal-processing means that are designed for processing other signals and enable the other signals to be processed using at least one other transmission parameter in a communication between the communication station and at least one other communication station, wherein the at least one transmission parameter for processing the signals with the first signal-processing means and the at least one transmission parameter for processing the other signals with the second signal-processing means are transmission parameters differing from each other.

2. A communication station as claimed in claim 1, wherein the first signal-processing means comprise first encoding means and first decoding means, which first encoding means and first decoding means are developed for processing signals according to at least one first coding type as the transmission parameter, and the second signal-processing means comprise second encoding means and second decoding means, which second encoding means and second decoding means are developed for processing the other signals according to at least one second coding type as the transmission parameter.

3. A communication station as claimed in claim 2, wherein the first encoding means are developed for processing the signals according to a Miller code, and the first decoding means are developed for processing the signals according to a Manchester code.

4. A communication station as claimed in claim 2, wherein the second encoding means and the second decoding means are developed for processing the other signals according to an NRZ code.

5. A communication station as claimed in claim 1, wherein the first signal-processing means comprise first modulation means and first demodulation means, which first modulation means and first demodulation means are developed for processing signals according to a first modulation type, and the second signal-processing means comprise second modulation means and second demodulation means, which second modulation means and second demodulation means are developed for processing the other signals according to a second modulation type.

6. A communication station as claimed in claim 5, wherein the first modulation means are formed by amplitude modulation means and the first demodulation means are formed by amplitude demodulation means.

7. A communication station as claimed in claim 5, wherein the second modulation means are formed by phase modulation means and the second demodulation means are formed by phase demodulation means.

8. A communication station as claimed in claim 7, wherein the phase modulation means and the phase demodulation means are developed to process the other signals according to the BPSK method.

9. An integrated circuit for a communication station which is suitable for contactless communication with transponders and with other communication stations, wherein the integrated circuit comprises first signal-processing means that are designed for processing signals and enable signals to be processed using at least one transmission parameter in a communication between the communication station and at least one transponder, and the integrated circuit comprises second signal-processing means that are designed for processing other signals and enable the other signals to be processed using at least one other transmission parameter in a communication between the communication station and at least one other communication station, and wherein the at least one transmission parameter for processing the signals with the first signal-processing means and the at least one transmission parameter for processing the other signals with the second signal-processing means are transmission parameters differing from each other.

10. An integrated circuit as claimed in claim 9, wherein the first signal-processing means comprise first encoding means and first decoding means, which first encoding means and first decoding means are developed for processing signals according to at least one first coding type as the transmission parameter, and the second signal-processing means comprise second encoding means and second decoding means, which second encoding means and second decoding means are developed for processing other signals according to at least one second coding type as the transmission parameter.

11. An integrated circuit as claimed in claim 10, wherein the first encoding means are developed for processing the signals according to a Miller code, and the first decoding means are developed for processing the signals according to a Manchester code.

12. An integrated circuit as claimed in claim 10, wherein the second encoding means and the second decoding means are developed for processing the other signals according to an NRZ code.

13. An integrated circuit as claimed in claim 9, wherein the first signal-processing means comprise first modulation means and first demodulation means, which first modulation means and first demodulation means are developed for processing signals according to a first modulation type, and the second signal-processing means comprise second modulation means and second demodulation means, which second modulation means and second demodulation means are developed for processing the other signals according to a second modulation type.

14. An integrated circuit as claimed in claim 13, wherein the first modulation means are formed by amplitude modulation means and the first demodulation means are formed by amplitude demodulation means.

15. An integrated circuit as claimed in claim 13, wherein the second modulation means are formed by phase modulation means, and the second demodulation means are formed by phase demodulation means.

16. An integrated circuit as claimed in claim 15, wherein the phase modulation means and the phase demodulation means are developed to process the other signals according to the BPSK method.
